(19) United States
(12) Patent Application Publication
(10) Pub. No.: US 2025/0348375 A1
(43) Pub. Date: Nov. 13, 2025

(54) SYSTEM AND METHOD FOR DATABASE SYSTEM ANOMALY DETECTION AND INCIDENT MANAGEMENT

(71) Applicant: Salesforce, Inc., San Francisco, CA (US)

(72) Inventor: Jyothi B. BALAKA, San Ramon, CA (US)

(73) Assignee: Salesforce, Inc., San Francisco, CA (US)

(21) Appl. No.: 18/659,385

(22) Filed: May 9, 2024

(51) Int. Cl. G06F 11/07; G06F 11/34

(52) U.S. Cl. CPC G06F 11/0793; G06F 11/0712; G06F 11/0766; G06F 11/3409

(57) ABSTRACT

Output metric values may be determined by applying a machine learning model to corresponding input metric values characterizing one or more operating conditions of a database system. The machine learning model may be pre-trained to project the input metric values into a latent space having a level of dimensionality lower than that of the input metric values and to project the latent space into the output metric values. The output metric values may be compared to the corresponding input metric values to identify corresponding discrepancy values indicating one or more discrepancies between the output metric values and the corresponding input metric values. A determination may be made that a database incident implicating operating conditions corresponding with a portion of the database system has occurred based on the corresponding discrepancy values, and an instruction may be transmitted to the database system to implement a policy to address the database incident.

### FIELD OF TECHNOLOGY

This patent application relates generally to database systems, and more specifically to anomaly detection and incident management.

### BACKGROUND

“Cloud computing” services provide shared resources, applications, and information to computers and other devices upon request. In cloud computing environments, services can be provided by one or more servers accessible over the Internet rather than installing software locally on in-house computer systems. Users can interact with cloud computing services to undertake a wide range of tasks. Many of the services provided by cloud computing environments are supported by database systems. Given the complexity of the computing environment and the many interactions both within the computing environment and between the computing environment and outside entities, cloud-accessible database systems commonly experience incidents that disrupt the services that they provide. Such disruptions can be particularly problematic given that database systems are integral to many cloud computing services.

Conventional approaches to incident detection and management in cloud computing environments lack specificity. Further, many such techniques are general-purpose in nature and fail to address the various additional considerations particular to specific types of database configurations, such as multi-tenant database systems. Accordingly, improved techniques and mechanisms for database system anomaly detection and incident management are desired.

### BRIEF DESCRIPTION OF THE DRAWINGS

The included drawings are for illustrative purposes and serve only to provide examples of possible structures and operations for the disclosed inventive systems, apparatus, methods, and computer program products for anomaly detection of database systems and incident management. These drawings in no way limit any changes in form and detail that may be made by one skilled in the art without departing from the spirit and scope of the disclosed implementations.

FIG. 1 illustrates an overview method for database system anomaly detection and incident management, performed in accordance with one or more embodiments.

FIG. 2 illustrates one example of a computing services environment, configured in accordance with one or more embodiments.

FIG. 3 illustrates a method to train a database anomaly detection model, performed in accordance with one or more embodiments.

FIG. 4 illustrates one example of a database system anomaly detection model, configured in accordance with one or more embodiments.

FIG. 5 illustrates a method for inference of a database anomaly detection model, performed in accordance with one or more embodiments.

FIG. 6 shows a method for incident detection of a database anomaly, performed in accordance with one or more embodiments.

FIG. 7 shows a block diagram of an example of an environment that includes an on-demand database service configured in accordance with some implementations.

FIG. 8A shows a system diagram of an example of architectural components of an on-demand database service environment, configured in accordance with some implementations.

FIG. 8B shows a system diagram further illustrating an example of architectural components of an on-demand database service environment, in accordance with some implementations.

FIG. 9 illustrates one example of a computing device, configured in accordance with one or more embodiments.

### DETAILED DESCRIPTION

Techniques and mechanisms described herein provide for anomaly detection and database incident management. In some configurations, such techniques and mechanisms may be enhanced through multi-tenant awareness. For instance, by comparing resource utilization metrics across different tenants and employing machine learning algorithms, the system can intelligently identify anomalies, enabling more precise incident detection, fair usage policy enforcement, and integration with service hardening techniques.

In some embodiments, the system may provide for multi-tenant resource utilization and comparison. Resource utilization metrics such as CPU, memory, and network bandwidth may be monitored for different tenants within a database environment. Resource metrics may be comparatively analyzed against historical and training data to establish tenant-specific baselines.

In some embodiments, machine learning algorithms may dynamically adapt to the evolving resource usage patterns of individual tenants. Such techniques and mechanisms may provide for real-time or near real-time anomaly detection based on deviations from established tenant-specific baselines. Anomaly triggers may be identified based on incident detection for affected tenants. Then, fair usage policies tailored to specific tenants may be implemented to provide for equitable resource distribution. Collaborative integration with service hardening techniques may be used to fortify the database environment against potential threats associated with detected anomalies.

In some embodiments, the disclosed system employs a multi-layered architecture that continuously collects and analyzes resource utilization metrics. Machine learning models dynamically adapt to changes in tenant behavior, providing for accurate anomaly detection. Incidents triggered by anomalies lead to the enforcement of fair usage policies and collaborative integration with service hardening techniques to enhance the overall security and stability of the database environment.

In some embodiments, historical data and training data are incorporated to establish instance-specific and/or tenant-specific baselines for resource utilization. Such an approach provides for taking into account the unique characteristics and patterns associated with different tenants and/or database system instances. In this way, the system dynamically adapts to evolving resource usage patterns for individual instances and/or tenants. This adaptability is crucial for accurately identifying anomalies specific to each tenant over time.

In some embodiments, anomalies detected in the system may trigger incident detection for the affected tenant in real-time or near real-time. This real-time response may provide for prompt action and provide monitoring more responsive than traditional systems relying on periodic reporting or manual intervention.

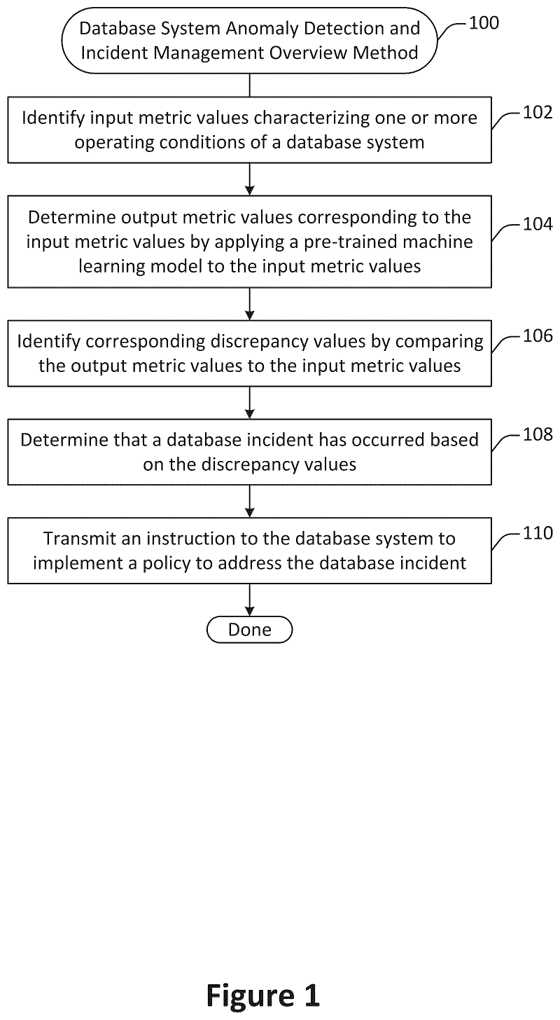

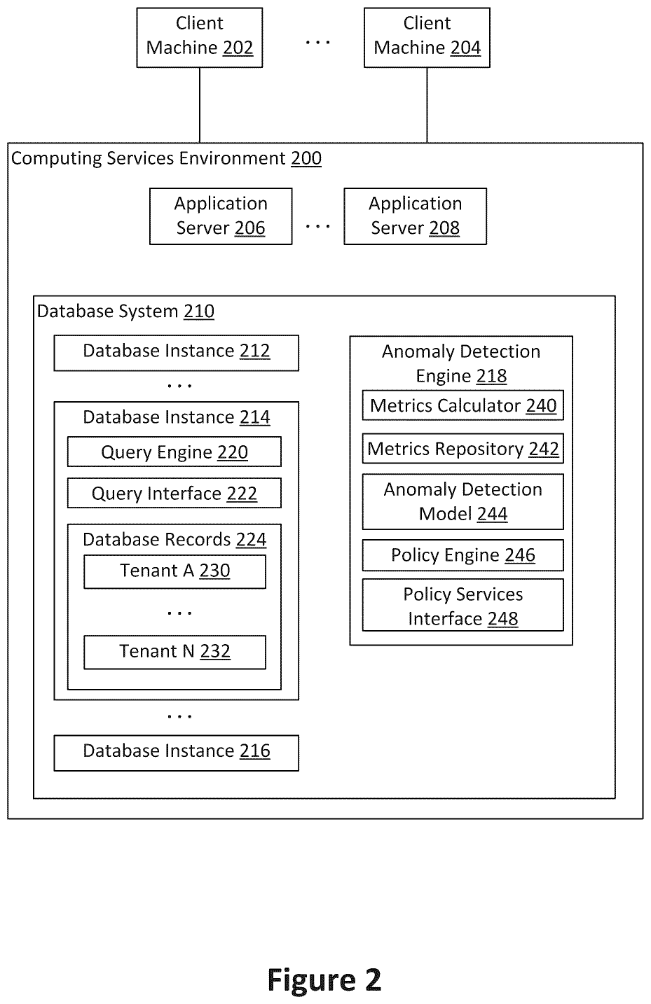

FIG. 1 illustrates an overview method 100 for database system anomaly detection and incident management. According to various embodiments, the method 100 may be performed on any suitable database system. For instance, the method 100 may be performed in a computing services environment configured to provide cloud computing services to various tenants via the Internet. Various details regarding an example of such an environment are discussed with respect to FIG. 2.

One or more input metric values are identified at 102. The input metric values may be received via a communication interface that communicates with an anomaly detection engine. The input metric values may characterize one or more operating conditions of a database system. For example, input metric values may include, but are not limited to, metrics characterizing hardware configuration, software environment, workload, concurrency and scalability, data volume and growth, access patterns and query complexity, and security and compliance requirements.

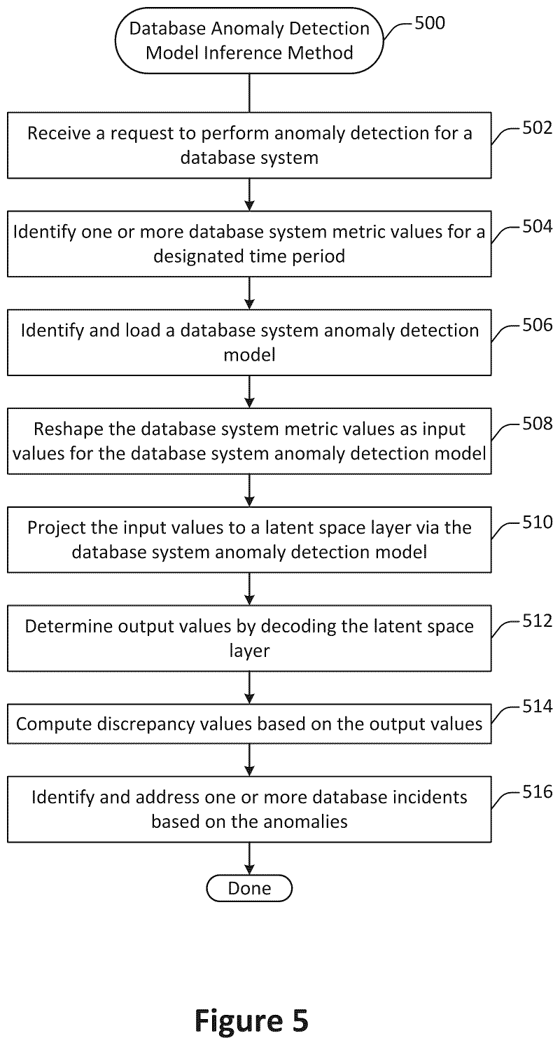

Output metric values corresponding to the input metric values are determined at 104. The output metric values may be determined by a processor by applying a pre-trained machine learning model to the input metric values 102. Any of various types of pre-trained machine learning models may be used to determine the output metric values. Additional details regarding determining output values that correspond to the input metric values are discussed throughout the application, for instance with respect to the method 500 shown in FIG. 5.

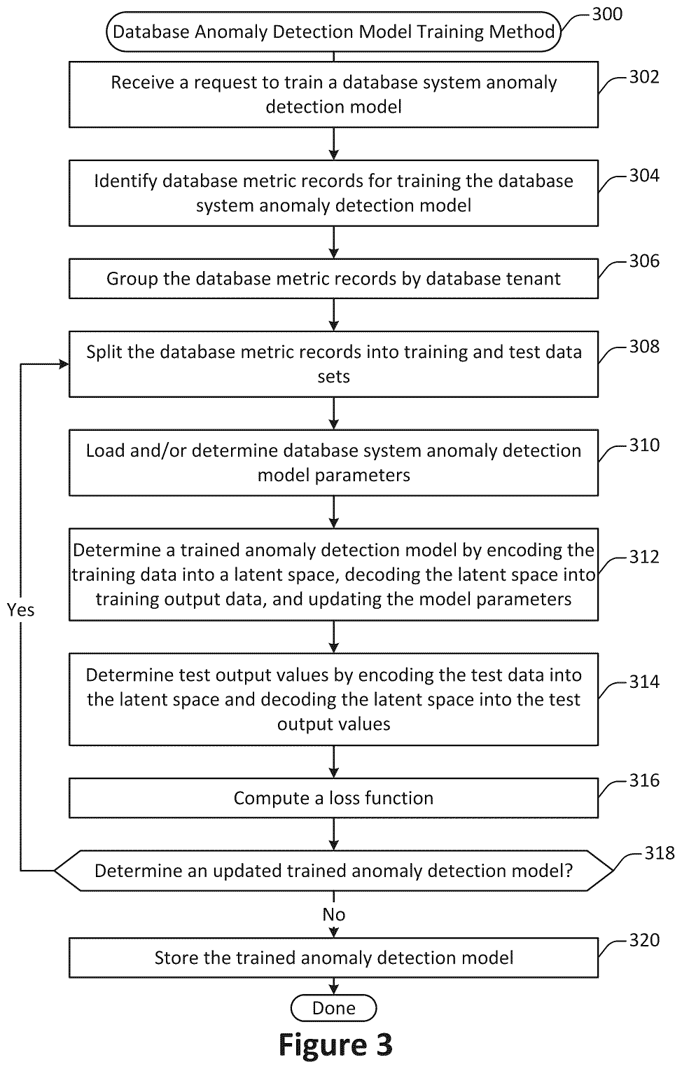

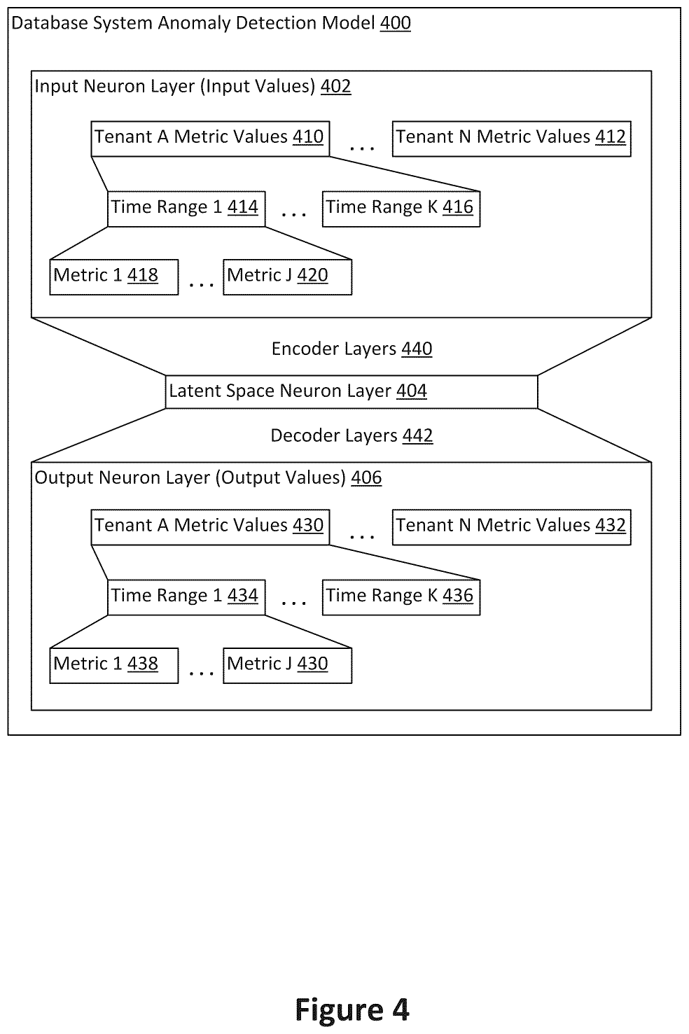

In some embodiments, the pre-trained machine learning model may be or include a variational autoencoder. An example of such a model is shown in FIG. 4. In such a configuration, the pre-trained machine learning model projects the input metric values via an encoder into a latent space having a level of dimensionality lower than that of the input metric values. The pre-trained machine learning model then projects the latent space into the output metric values, which correspond to the input metric values. Additional details regarding determining a pre-trained machine learning model are discussed with respect to the method 304 shown in FIG. 3.

Discrepancy values corresponding with the input and output metric values are identified at 106. In some embodiments, the discrepancy values are identified by comparing the output metric values with the input metric values. The discrepancy values may indicate one or more discrepancies between the output metric values and the corresponding input metric values. Additional details regarding the calculation of the discrepancy values are discussed with respect to the method 500 shown in FIG. 5.

At 108, a determination that a database incident has occurred is made based on the discrepancy values determined as discussed with respect to the operation 106. In some implementations, the identified database incident may indicate that an anomaly has occurred in the operating conditions corresponding with a portion of the database system. For instance, the discrepancy values may indicate that the CPU usage for a particular tenant is significantly higher than predicted given the totality of the input values, suggesting the occurrence of a database incident pertaining to the tenant.

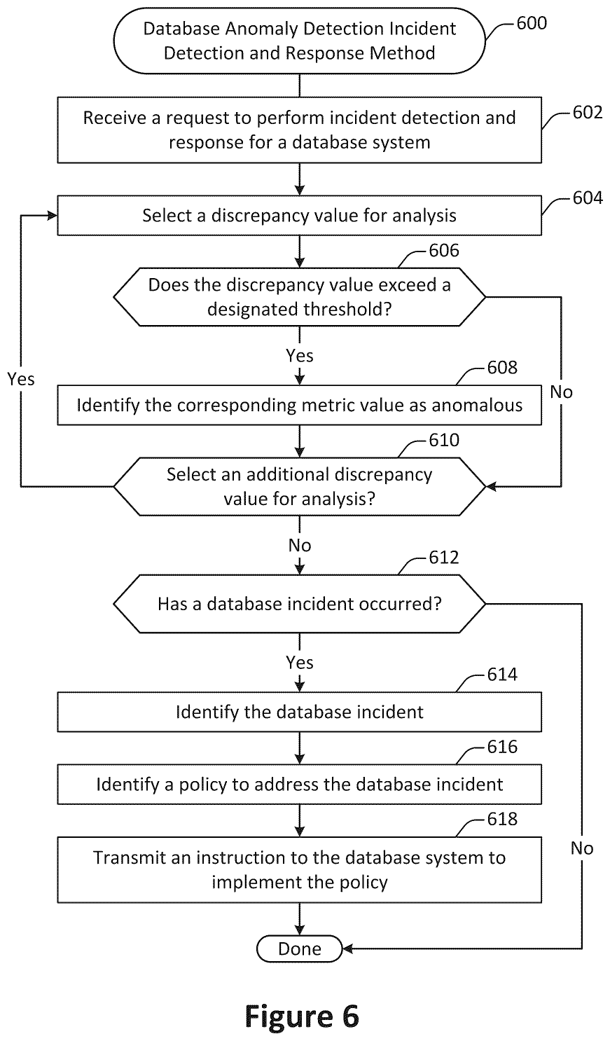

An instruction is transmitted at 110 to the database system via a communication interface. In some embodiments, the instruction may include information regarding the database anomaly detected and/or one or more policies designed to address the database incident. For example, the database system may be instructed to throttle, isolate, and/or transfer a tenant whose activities risk affecting database system operations. Additional details regarding the identification of and response to database incidents are discussed with respect to the method 618 shown in FIG. 6.

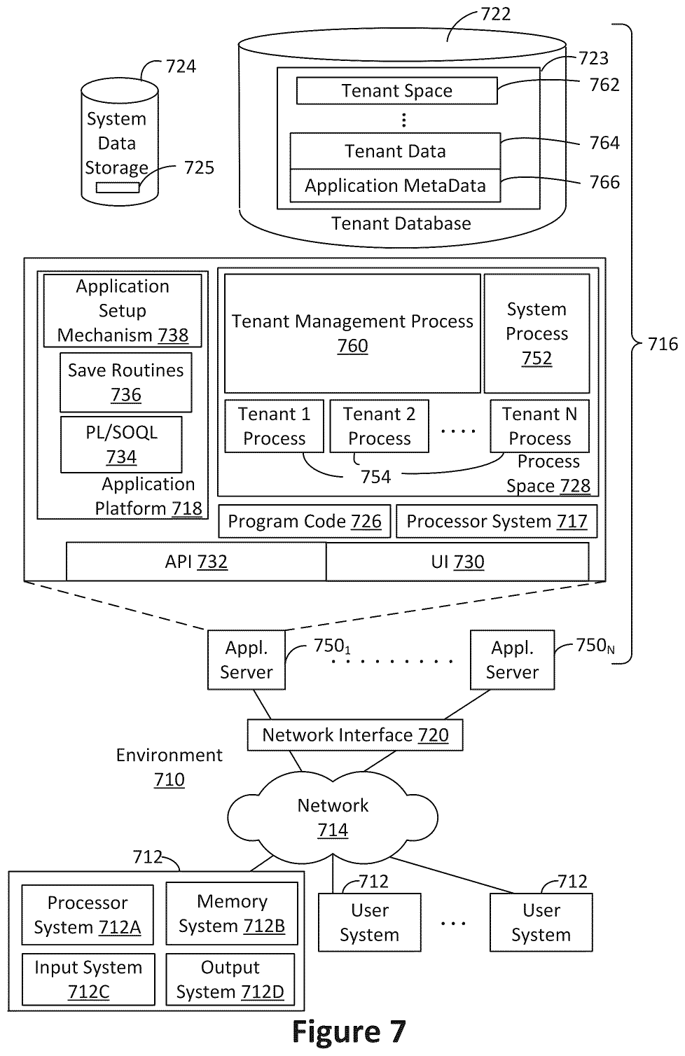

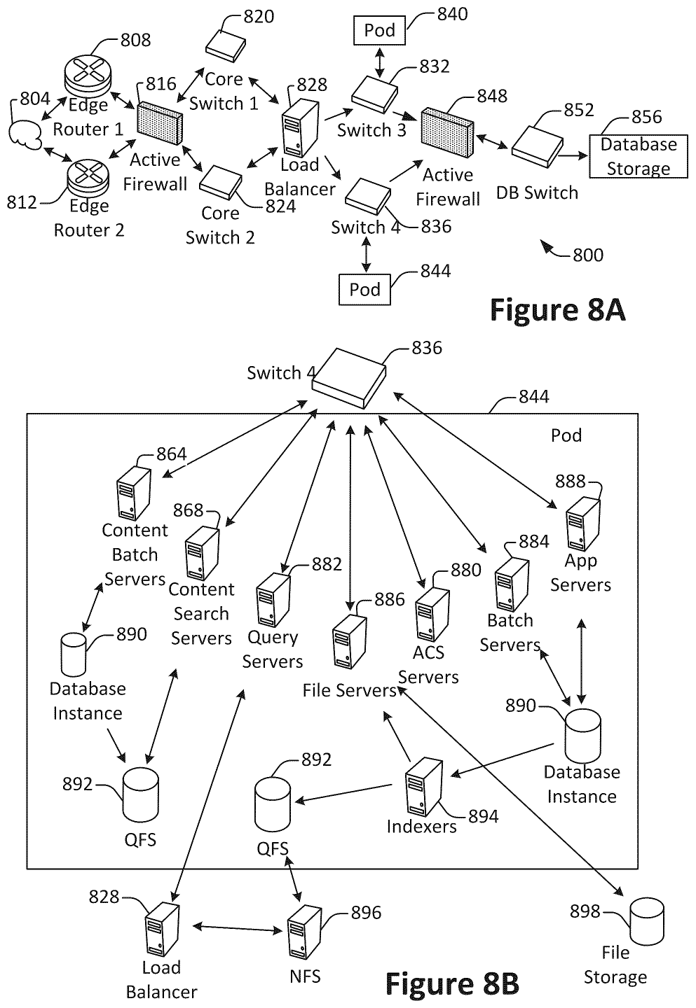

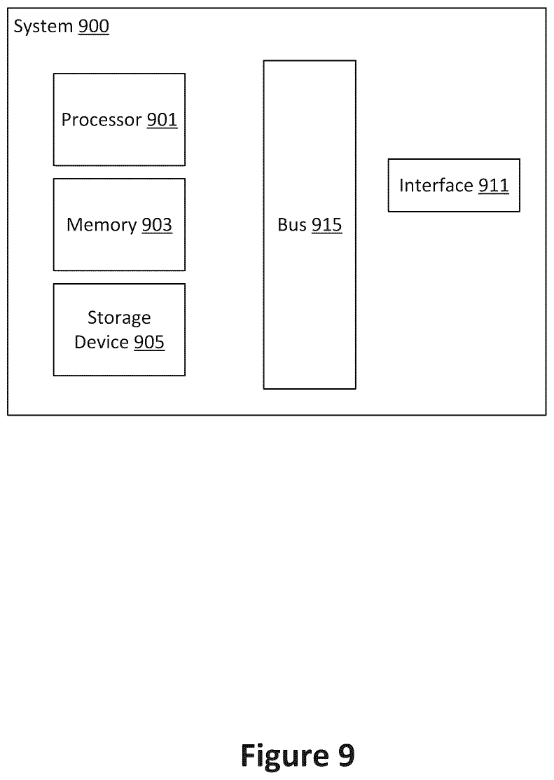

FIG. 2 illustrates one example of a computing services environment 200, configured in accordance with one or more embodiments. The computing services environment 200 includes one or more application servers (indicated as 206 and 208), and a database system 210. The database system 210 includes one or more database instances (e.g., the instances 212, 214, and 216) and an anomaly detection engine 218. The database instance 214 includes a query engine 220, query interface 222, and database records 224. The database records 224 includes one or more tenant records (e.g., tenant A at 230 through tenant N at 232). The anomaly detection engine 218 includes a metrics calculator 240, a metrics repository 242, an anomaly detection model 244, a policy engine 246, and a policy services interface 248. The computing services 200 communicates with one or more client machines (e.g., the client machines 202 and 204). Additional details regarding various elements that may be included in a computing services environment are discussed with respect to FIG. 7, FIG. 8A, FIG. 8B, and FIG. 9.

In some implementations, the application servers 206 and 208 may provide access to one or more web applications accessible via the computing services environment 200, which may be backed by the database system 210. The computing services may be provided to the one or more client machines. The client machines may include external machines, cloud machines, external application servers, and/or any other suitable computing devices accessing computing services via the computing services environment 200. The client machines may communicate with the computing services environment 200 to access computing services such as on-demand database services, customer relations management services, sales support services, and the like.

In some implementations, some or all of the data and/or operations within the database system 210 may be divided into one or more database instances such as the instances 212, 214, and 216. Different instances may correspond to different geographic locations or regions, different tenants of the database system, different types of data, and/or other divisions. Different database systems may include different numbers, types, and configurations of database instances.

The query engine at 220 may process and execute queries against the database. In some embodiments, the query engine may employ various optimization techniques. For example, the query engine may perform operations such as indexing, query planning, query rewriting, join reordering, predicate pushdown, parallel execution, and other and data access methods to reduce response time and resource consumption.

The query interface at 222 may communicate with any component in the computing services environment 200. According to various embodiments, the query interface may take various forms, including, and not limited, to command-line interfaces (CLI), graphical user interfaces (GUI), application programming interfaces (API), and web-based interfaces. The query interface may provide features such as query composition, syntax highlighting, query execution monitoring, result visualization, and error handling, for instance to enhance the user experience and productivity.

According to various embodiments, the anomaly detection engine 218 may identify patterns, behaviors, or events that deviate from the expected or normal baseline. According to various embodiments, anomalies may indicate potential errors, abnormalities, fraud, security breaches, or other noteworthy events that require attention or investigation. For instance, anomalies may indicate unusual or problematic database usage by one or more tenants of the database system. Identifying and addressing such situations may be particularly important in a multi-tenant environment to avoid a situation in which one tenant's service is disrupted by another tenants' usage.

The metrics repository at 242 may store metric values characterizing one or more operating conditions of a database system. In some embodiments, such metrics values may be determined by the metrics calculator at 240. For example, metric values may include, but are not limited to, metrics characterizing hardware configuration, software environment, workload, concurrency and scalability, data volume and growth, access patterns and query complexity, and security and compliance requirements. The metrics repository may include historical and/or pre-processed metric values. For example, the metrics repository may have stored a previously detected database anomaly for a particular database tenant.

In some embodiments, database metrics may be used for anomaly detection based on performance metrics to evaluate the effectiveness and accuracy of the anomaly detection system. For instance, the calculation may aid in fine-tuning the parameters of the anomaly detection model, evaluating its performance over time, comparing different algorithms, and making decisions about the effectiveness of the database system anomaly detection engine.

According to various embodiments, the anomaly detection model at 244 may identify abnormal behavior or events in the database. The anomaly detection model may detect previously classified and unclassified anomalies using a machine learning model. For instance, the machine learning model may include one or more of an autoencoder, a variational autoencoder, a generative artificial intelligence model such as a generative adversarial network, or a large language model.

According to various embodiments, the policy engine at 246 may define, evaluate, and/or enforce policies related to database system incident detection and response. For example, the policy engine may evaluate incoming data, detected anomalies, and contextual information against defined policies to determine the appropriate course of action. For example, the policy engine may generate alerts, triggering automated responses, or initiating manual interventions. As another example, the policies defined by the policy engine may include criteria for anomaly severity levels, response strategies, escalation procedures, notification thresholds, and mitigation actions.

In some embodiments, the policy services interface 248 allows systems and applications to interact with the policy engine and manage policy configuration, monitoring, and administration. The policy services interface may communicate with other systems to synchronize information related to a candidate database system anomaly. For example, the policy services may communicate with security information and event management (SIEM) platforms, incident response systems, or orchestration tools. As another example, the policy services interface may communicate contextual information, and coordinate responses across multiple domains. Additional details regarding the operation of the policy engine and the policy services interface for database incident detection and response for database incident detection and response are discussed with respect to the method 600 in FIG. 6.

FIG. 3 illustrates a method 300 of training a database anomaly detection model, performed in accordance with one or more embodiments. The method 300 may be performed at any suitable database system. For instance, the method 300 may be performed in a database system configured to provide cloud computing services to various tenants via the Internet, such as the database system 200 shown in FIG. 2.

FIG. 3 is described partially in reference to FIG. 4, which illustrates one example of a database system anomaly detection model 400 configured in accordance with one or more embodiments. The database system anomaly detection model 400 includes an input neuron layer (input values) 402, a latent space neuron layer 404, and an output neuron layer (output values) 406. The input neuron layer 402 contains tenant metric values (indicated as tenant A metric values at 410 and tenant N metric values at 412), time ranges (indicated as time range 1 at 414 and time range K at 416), and metrics (indicated as metric 1 at 418 and metric J at 420). The output neuron layer 406 contains tenant metric values (indicated as tenant A metric values at 430 and tenant N metric values at 432), time ranges (indicated as time range 1 at 434 and time range K at 436), and metrics (indicated as metric 1 at 438 and metric J at 440).

Returning to FIG. 3, a request to train a database system anomaly detection model is received at 302. In some embodiments, the request may be transmitted via an application procedure interface and may indicate a desire to train a database system anomaly detection model for a particular database instance. The request may include a set of metric records the model should be trained on. For example, metric records communicated via the request may include tenant metric values, time ranges, and other metrics for a given time range.

According to various embodiments, the database system anomaly detection model may be trained periodically and/or when a triggering condition is detected. For example, the database system anomaly detection model may be trained when a sufficient amount of new training data becomes available, on a weekly or monthly basis, when the performance of the existing model falls below a designated threshold, or when some other triggering condition is met.

Database metric records for training the database system anomaly detection model are identified at 304. The database metrics records may be determined by one or more techniques. For example, the database metrics records may be pre-processed and loaded from the metrics repository at 242. As another example, the metrics calculator 240 may be used to determine the appropriate database metrics to use based on performance metrics to evaluate the effectiveness and accuracy of the anomaly detection system. As yet another example, the database metric records may be determined by selecting a subset of all database metric records based on the request received as discussed with respect to the operation 302.

In FIG. 4, the input neuron layer at 402 receives raw input data from an external source, such as the metrics repository. According to various embodiments, the metric values may include text, numerical data, or any other form of structured and/or unstructured data that may help the database system anomaly detection model determine an anomaly. For example, input metric values may include, but are not limited to, metrics characterizing hardware configuration, software environment, workload, concurrency and scalability, data volume and growth, access patterns and query complexity, and security and compliance requirements.

Returning to FIG. 3, database metric records are optionally grouped by database tenant at 306. According to various embodiments, grouping the database metric records by tenant may allow for the detection of database incidents that are specific to a particular tenant. In some configurations, the database metrics grouped by tenant may include all database metric records for a particular tenant for a given time frame.

In FIG. 4, the tenant metric values (tenant A metric values at 410 and tenant N metric values at 412) indicate the metric values for a particular tenant. These tenant metric values include information that may be relevant for determining whether a database incident or anomaly has occurred.

In some embodiments, the metric values may be grouped by time range. For instance, the input tenant A metric values 410 includes values for time ranges 414 through 416. The time ranges indicate the time window that contain the metrics to evaluate. For instance, the metrics 418 through 420 were captured during time range 1 414. In this way, metrics captured over a set of time ranges may be analyzed in the same model.

Returning to FIG. 3, database metric records are split into training and test data sets at 308. The training set will be used to train the model and the test data set will be used to evaluate the trained model's performance. According to some embodiments, splitting the database metric records into training and test data sets may be done by one or more techniques to improve the models' performance. For example, splitting the training data set must contain sufficient anomalies to aid with the training process. For another example, stratified sampling may be used to ensure anomalies will be present in the test data set. As yet another example, k-fold validation may be used to separate the data into multiple training segments.

Database system anomaly detection model parameters are loaded and/or determined at 310. In some embodiments, the database system anomaly detection model may be initialized with parameters determined based on a previous iteration of model training. Alternatively, the model may be initialized with a default set of parameters, for instance if a previous version of the model is unavailable.

A trained anomaly detection model is determined at 312. The training of an anomaly detection model may include encoding the training data into a latent space, decoding the latent space into a training output data, and updating the model parameters.

As shown in FIG. 4, the encoding layers 440 in the encoder operation of an autoencoder are responsible for transforming the input data into a lower-dimensional latent space representation referred to as the latent space neuron layer 404. These encoding layers 440 progressively compress the input information until the information reaches the latent space neuron layer 404. The latent space neuron layer at 404 is a projected representation of the input neuron layer 402. The size of the projected representation may be less than the input and output value sizes. The latent space is then decoded into the output neuron layer at 406 via the decoder layers 442. The output neuron layer attempts to reconstruct the input values 402 by decoding the latent space representation of the input values at the latent space neuron layer 404. For example, the decoder layers 442 aim to reconstruct the original input data from the latent space representation obtained from the encoder.

In some embodiments, the decoder layers 442 progressively expand the information back to its original dimensionality such that each of the output values corresponds to a respective input value. For example, tenant metric values (indicated as Tenant A at 430 and Tenant N at 432) in the output neuron layer represent the reconstructed metric values for tenant A. The time ranges (time range 1 at 434 and time range K at 436) indicate the reconstructed time ranges of input neuron layer. Metric values (metric 1 at 438 and metric J at 430) are reconstructed metrics of the input neuron layer. The reconstructed values (output values) can be used to determine an anomaly by comparing them with their corresponding input values.

Returning to FIG. 3, the test output values are determined at 314. In some embodiments, the test output values may be calculated by encoding the test data into the latent space and decoding the latent space into the test output values.

A loss function is computed at 316. According to various embodiments, the loss function may include a variety of factors and parameters to improve the models' performance during training. For example, the loss function may include the reconstruction loss (i.e., calculating the difference between the input and output values). For another example, the loss function may also calculate the Kullback-Leibler (KL) divergence.

At 318, a determination is made as to whether to update the trained anomaly detection model. According to various embodiments, a variety of techniques may be used to determine retraining. For example, calculating the discrepancy of the loss function determined as discussed with respect to the operation 316. For another example, the model's performance may also be used to determine if the model should be retrained. Techniques to determine the model's performance may include, but are not limited to, calculating the metrics for precision, recall, and F1 score.

The trained anomaly detection model is stored at 320. In some embodiments, additional data may also be stored along with the trained database anomaly detection model. For example, additional data stored may include, but is not limited to, metadata, model size, dimensions, number of layers, model parameters, number of epochs required for training, resources required to train the mode.

In some embodiments, multiple models may be trained. For example, different database instances may each have their own model to reflect instance-level variation in detecting and addressing anomalies and incidents.

FIG. 5 illustrates a method 500 for inferring a database anomaly detection model, configured in accordance with some implementations. According to various embodiments, a database anomaly may be detected by the discrepancy between the input metric values and output metric values. The output metric values may be determined by a processor by applying a pre-trained machine learning model to the input metric values. Any of various types of pre-trained machine learning models may be used to determine the output metric values. The discrepancy may be saved for future assessment of database incidents.

A request to perform anomaly detection for a database system is received at 502. The request may be triggered on demand or pre-scheduled to run at a pre-determined interval. In some embodiments, such a request may be generated periodically. For instance, anomaly detection may be performed once per minute, once per hour, or at any other suitable intervial. Alternatively, or additionally, incident detection may be performed when a triggering condition is met. For instance, anomaly detection may be performed when some indication of database performance falls below a designated threshold.

One or more database system metric values for a designated time period are identified at 504. Identifying the database system metric values may include loading from the metrics repository 242 and/or selecting the database system metric values based on the available inputs from the request received as discussed with respect to the operation 502. The designated time period may be selected by adjusting the window size to take into account anomalies that span across a larger time horizon.

In some embodiments, the one or more database system metric values may include details about the database instance, including, and not limited, to previous anomalies, tenant database information, and time ranges such as the starting and ending time for metric values. For example, the causal relation for some anomalies may occur in larger timespans and the anomaly detection system may require a larger time window size to compare the input and output values.

A pre-trained database system anomaly detection model is identified and loaded at 506. In some embodiments, the database system anomaly detection model is selected based on the request received at operation 504. For example, different database instances may be associated with different anomaly detection models.

The database system metric values are reshaped for the database system anomaly detection model at 508. In some embodiments, reshaping the values may involve, for instance, shaping the raw input values to a format that matches the input values of the pretrained database system anomaly detection model.

According to various embodiments, the mapping of database system metric values may be reshaped to increase, decrease, or stay the same size. For example, the database system metric values may be a vector of size 100 and the input values for the database system anomaly detection model is a vector of size 90. As another example, the database system metric values may be a vector of size 100 and the input value for the database system anomaly detection model is a vector of size 110.

The input values are projected to a latent space layer via the database system anomaly detection model at 510. Output values are determined by decoding the latent space layer at 512. The database system anomaly detection model encodes the input values into a latent space that is of smaller size than the input values. For example, the input values may be a vector of size 10,000 neurons while the encoded latent space values is a vector of size 1,500 neurons. The latent space neuron values may then be decoded into an output vector of size 10,000 neurons.

Discrepancy values are computed based on the output values at 514. In some embodiments, the discrepancy values may be generated by calculating the difference between the input and output values. Such differences may be indicative of a database anomaly. For example, the larger the variance in discrepancy, the greater probability of there being a database anomaly.

At 516, one or more database incidents are identified and addressed based on the anomalies. In some embodiments, the discrepancy values discussed with respect to the operation 514 may be selected when identifying a database incident. For instance, if the discrepancy values contained a large variance for the CPU usage for a particular tenant, then the database incident may be identified at least in part as relating to unexpectedly large CPU usage for that tenant. Additional details regarding such techniques are discussed with respect to the method 600 shown in FIG. 6.

FIG. 6 shows a method 600 for database anomaly incident detection and response, performed in accordance with some implementations. According to various embodiments, incident detection and response may involve analyzing one or more candidate discrepancy values to identify a database incident. The method 600 may be performed at the anomaly detection engine 218, which may communicate with one or more other elements of the database system to implement a policy based on the database incident.

A request to perform incident detection and response for a database system is received at 602. In some implementations, the request may be generated as discussed with respect to the operation 516 shown in FIG. 5. The request may include or indicate information about the discrepancy values collected during the input and output of database anomaly detection model inference.

A discrepancy value is selected for analysis at 604. In some embodiments, the discrepancy value may be selected based on a triage priority operation. For example, the discrepancy value is selected by sorting the discrepancy values by order of importance. As another example, the discrepancy values may be sorted in ascending order by variance and select the discrepancy value with the largest variance. As still another possibility, multiple discrepancy values may be analyzed in parallel.

At 606, a determination is made as to whether a discrepancy value exceeds a designated threshold. In some embodiments, the designated threshold value may be pre-computed. For example, the reconstruction errors calculated in operation 514 may be the designated threshold value. Alternatively, the designated threshold is based on historical data from previous database system metric values. For example, if the same database system metric value is identified as a discrepancy value more than a designated threshold.

In some implementations, the designated threshold value may be based on distributional information, which may be computed based on historical calculations of discrepancy values. For instance, the designated threshold value may be a number of standard deviations (e.g., 2.5 standard deviations) from the mean reconstruction value.

Upon determining that the discrepancy value exceeds the designated threshold, the corresponding metric value is identified as anomalous at 608. As discussed herein, a discrepancy value may be based on a difference between an output value and a corresponding input value. Identifying the database system metric value as anomalous may include storing relevant information in the database to be used in incident management and/or future model training.

A determination is made at 610 as to whether to select an additional discrepancy value for analysis. In some embodiments, additional discrepancy values may continue to be analyzed until all discrepancy values have been analyzed. Alternatively, discrepancy values above a designated threshold may be analyzed.

At 612, a determination is made as to whether a database incident has occurred. In some embodiments, the determination may be based on the anomalous discrepancy metric values identified in operation 608.

According to various embodiments, the determination factor of a database incident may be based on one or more factors. For example, the detection of any anomalous database system metric values at 608 may automatically trigger the detection of a database incident. Particularly in a configuration where anomalous metric values are rare, such as any discrepancy between the input and output metric values may be classified as a database incident.

According to various embodiments, historical data may be used to determine if the databases system metric values identified as anomalous in 608 are indicative of a database incident. For example, the anomaly detection engine may look at the metrics repository 242 to infer whether previously classified anomalous database system metric values were accurately classified as a database incident.

The database incident is identified at 614. In some embodiments, identifying the database incident may involve applying one or more rules and/or classification models. For example, a second model may be pretrained using database incident labels and anomalous metric values. The second model may then be applied to the anomalous metric values to produce a classification that indicates the type and/or source of a database incident. For instance, a combination of high CPU usage and high database requests for a particular tenant may indicate one type of database incident, while high memory usage combined with high read throughput may indicate a different type of database incident. Information characterizing the database incident may be stored in the database system, for instance to be used in future model training.

A policy to address the database incident is identified at 616. In some embodiments, the policy may be selected based on the database incident identified as discussed with respect to the operation 614. For example, if a database incident includes an anomaly regarding the CPU, the policy selected may be one that specifically addresses the CPU. As another example, if the database incident involves anomalous usage by a particular database tenant, then database usage by that tenant may be throttled. The policy selection operation may be informed by historical information regarding policies selected for previously detected similar database incidents.

An instruction is transmitted to the database system to implement the policy at 618. The instruction is transmitted via the communication interface to address the database incident. In some embodiments, the instruction may include information regarding the database anomaly detected and/or one or more policies designed to address the database incident. For example, the database system may be instructed to throttle, isolate, and/or transfer a tenant whose activities risk affecting database system operations.

FIG. 7 shows a block diagram of an example of an environment 710 that includes an on-demand database service configured in accordance with some implementations. Environment 710 may include user systems 712, network 714, database system 716, processor system 717, application platform 718, network interface 720, tenant data storage 722, tenant data 723, system data storage 724, system data 725, program code 726, process space 728, User Interface (UI) 730, Application Program Interface (API) 732, PL/SOQL 734, save routines 736, application setup mechanism 738, application servers 750-1 through 750-N, system process space 752, tenant process spaces 754, tenant management process space 760, tenant storage space 762, user storage 764, and application metadata 766. Some of such devices may be implemented using hardware or a combination of hardware and software and may be implemented on the same physical device or on different devices. Thus, terms such as “data processing apparatus,” “machine,” “server” and “device” as used herein are not limited to a single hardware device, but rather include any hardware and software configured to provide the described functionality.

An on-demand database service, implemented using system 716, may be managed by a database service provider. Some services may store information from one or more tenants into tables of a common database image to form a multi-tenant database system (MTS). As used herein, each MTS could include one or more logically and/or physically connected servers distributed locally or across one or more geographic locations. Databases described herein may be implemented as single databases, distributed databases, collections of distributed databases, or any other suitable database system. A database image may include one or more database objects. A relational database management system (RDBMS) or a similar system may execute storage and retrieval of information against these objects.

In some implementations, the application platform 718 may be a framework that allows the creation, management, and execution of applications in system 716. Such applications may be developed by the database service provider or by users or third-party application developers accessing the service. Application platform 718 includes an application setup mechanism 738 that supports application developers' creation and management of applications, which may be saved as metadata into tenant data storage 722 by save routines 736 for execution by subscribers as one or more tenant process spaces 754 managed by tenant management process 760 for example. Invocations to such applications may be coded using PL/SOQL 734 that provides a programming language style interface extension to API 732. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications may be detected by one or more system processes. Such system processes may manage retrieval of application metadata 766 for a subscriber making such an invocation. Such system processes may also manage execution of application metadata 766 as an application in a virtual machine.

In some implementations, each application server 750 may handle requests for any user associated with any organization. A load balancing function (e.g., an F5 Big-IP load balancer) may distribute requests to the application servers 750 based on an algorithm such as least-connections, round robin, observed response time, etc. Each application server 750 may be configured to communicate with tenant data storage 722 and the tenant data 723 therein, and system data storage 724 and the system data 725 therein to serve requests of user systems 712. The tenant data 723 may be divided into individual tenant storage spaces 762, which can be either a physical arrangement and/or a logical arrangement of data. Within each tenant storage space 762, user storage 764 and application metadata 766 may be similarly allocated for each user. For example, a copy of a user's most recently used (MRU) items might be stored to user storage 764. Similarly, a copy of MRU items for an entire tenant organization may be stored to tenant storage space 762. A UI 730 provides a user interface and an API 732 provides an application programming interface to system 716 resident processes to users and/or developers at user systems 712.

System 716 may implement a web-based database anomaly detection system. For example, in some implementations, system 716 may include application servers configured to implement and execute database anomaly detection software applications. The application servers may be configured to provide related data, code, forms, web pages and other information to and from user systems 712. Additionally, the application servers may be configured to store information to, and retrieve information from a database system. Such information may include related data, objects, and/or Webpage content. With a multi-tenant system, data for multiple tenants may be stored in the same physical database object in tenant data storage 722, however, tenant data may be arranged in the storage medium(s) of tenant data storage 722 so that data of one tenant is kept logically separate from that of other tenants. In such a scheme, one tenant may not access another tenant's data, unless such data is expressly shared.

Several elements in the system shown in FIG. 7 include conventional, well-known elements that are explained only briefly here. For example, user system 712 may include processor system 712A, memory system 712B, input system 712C, and output system 712D. A user system 712 may be implemented as any computing device(s) or other data processing apparatus such as a mobile phone, laptop computer, tablet, desktop computer, or network of computing devices. User system 12 may run an internet browser allowing a user (e.g., a subscriber of an MTS) of user system 712 to access, process and view information, pages and applications available from system 716 over network 714. Network 714 may be any network or combination of networks of devices that communicate with one another, such as any one or any combination of a LAN (local area network), WAN (wide area network), wireless network, or other appropriate configuration.

The users of user systems 712 may differ in their respective capacities, and the capacity of a particular user system 712 to access information may be determined at least in part by “permissions” of the particular user system 712. As discussed herein, permissions generally govern access to computing resources such as data objects, components, and other entities of a computing system, such as a database anomaly detection system, a social networking system, and/or a CRM database system. “Permission sets” generally refer to groups of permissions that may be assigned to users of such a computing environment. For instance, the assignments of users and permission sets may be stored in one or more databases of System 716. Thus, users may receive permission to access certain resources. A permission server in an on-demand database service environment can store criteria data regarding the types of users and permission sets to assign to each other. For example, a computing device can provide to the server data indicating an attribute of a user (e.g., geographic location, industry, role, level of experience, etc.) and particular permissions to be assigned to the users fitting the attributes. Permission sets meeting the criteria may be selected and assigned to the users. Moreover, permissions may appear in multiple permission sets. In this way, the users can gain access to the components of a system.

In some an on-demand database service environments, an Application Programming Interface (API) may be configured to expose a collection of permissions and their assignments to users through appropriate network-based services and architectures, for instance, using Simple Object Access Protocol (SOAP) Web Service and Representational State Transfer (REST) APIs.

In some implementations, a permission set may be presented to an administrator as a container of permissions. However, each permission in such a permission set may reside in a separate API object exposed in a shared API that has a child-parent relationship with the same permission set object. This allows a given permission set to scale to millions of permissions for a user while allowing a developer to take advantage of joins across the API objects to query, insert, update, and delete any permission across the millions of possible choices. This makes the API highly scalable, reliable, and efficient for developers to use.

In some implementations, a permission set API constructed using the techniques disclosed herein can provide scalable, reliable, and efficient mechanisms for a developer to create tools that manage a user's permissions across various sets of access controls and across types of users. Administrators who use this tooling can effectively reduce their time managing a user's rights, integrate with external systems, and report on rights for auditing and troubleshooting purposes. By way of example, different users may have different capabilities with regard to accessing and modifying application and database information, depending on a user's security or permission level, also called authorization. In systems with a hierarchical role model, users at one permission level may have access to applications, data, and database information accessible by a lower permission level user, but may not have access to certain applications, database information, and data accessible by a user at a higher permission level.

As discussed above, system 716 may provide on-demand database service to user systems 712 using an MTS arrangement. By way of example, one tenant organization may be a company that employs a sales force where each salesperson uses system 716 to manage their sales process. Thus, a user in such an organization may maintain contact data, leads data, customer follow-up data, performance data, goals and progress data, etc., all applicable to that user's personal sales process (e.g., in tenant data storage 722). In this arrangement, a user may manage his or her sales efforts and cycles from a variety of devices, since relevant data and applications to interact with (e.g., access, view, modify, report, transmit, calculate, etc.) such data may be maintained and accessed by any user system 712 having network access.

When implemented in an MTS arrangement, system 716 may separate and share data between users and at the organization-level in a variety of manners. For example, for certain types of data each user's data might be separate from other users' data regardless of the organization employing such users. Other data may be organization-wide data, which is shared or accessible by several users or potentially all users form a given tenant organization. Thus, some data structures managed by system 716 may be allocated at the tenant level while other data structures might be managed at the user level. Because an MTS might support multiple tenants including possible competitors, the MTS may have security protocols that keep data, applications, and application use separate. In addition to user-specific data and tenant-specific data, system 716 may also maintain system-level data usable by multiple tenants or other data. Such system-level data may include industry reports, news, postings, and the like that are sharable between tenant organizations.

In some implementations, user systems 712 may be client systems communicating with application servers 750 to request and update system-level and tenant-level data from system 716. By way of example, user systems 712 may send one or more queries requesting data of a database maintained in tenant data storage 722 and/or system data storage 724. An application server 750 of system 716 may automatically generate one or more SQL statements (e.g., one or more SQL queries) that are designed to access the requested data. System data storage 724 may generate query plans to access the requested data from the database.

The database systems described herein may be used for a variety of database applications. By way of example, each database can generally be viewed as a collection of objects, such as a set of logical tables, containing data fitted into predefined categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. Database anomaly detection may aid with the detection of anomalies in the CRM database. For CRM database applications, such standard entities might include tables for case, account, contact, lead, and opportunity data objects, each containing pre-defined fields. It should be understood that the word “entity” may also be used interchangeably herein with “object” and “table”.

In some implementations, tenants may be allowed to create and store custom objects, or they may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in an MTS. In certain implementations, for example, all custom entity data rows may be stored in a single multi-tenant physical table, which may contain multiple logical tables per organization. It may be transparent to customers that their multiple “tables” are in fact stored in one large table or that their data may be stored in the same table as the data of other customers.

FIG. 8A shows a system diagram of an example of architectural components of an on-demand database service environment 800, configured in accordance with some implementations. A client machine located in the cloud 804 may communicate with the on-demand database service environment via one or more edge routers 808 and 812. A client machine may include any of the examples of user systems 712 described above. The edge routers 808 and 812 may communicate with one or more core switches 820 and 824 via firewall 816. The core switches may communicate with a load balancer 828, which may distribute server load over different pods, such as the pods 840 and 844 by communication via pod switches 832 and 836. The pods 840 and 844, which may each include one or more servers and/or other computing resources, may perform data processing and other operations used to provide on-demand services. Components of the environment may communicate with a database storage 856 via a database firewall 848 and a database switch 852.

Accessing an on-demand database service environment may involve communications transmitted among a variety of different components. The environment 800 is a simplified representation of an actual on-demand database service environment. For example, some implementations of an on-demand database service environment may include anywhere from one to many devices of each type. Additionally, an on-demand database service environment need not include each device shown, or may include additional devices not shown, in FIGS. 8A and 8B.

The cloud 804 refers to any suitable data network or combination of data networks, which may include the Internet. Client machines located in the cloud 804 may communicate with the on-demand database service environment 800 to access services provided by the on-demand database service environment 800. By way of example, client machines may access the on-demand database service environment 800 to retrieve, store, edit, and/or process database anomaly detection information.

In some implementations, the edge routers 808 and 812 route packets between the cloud 804 and other components of the on-demand database service environment 800. The edge routers 808 and 812 may employ the Border Gateway Protocol (BGP). The edge routers 808 and 812 may maintain a table of IP networks or ‘prefixes’, which designate network reachability among autonomous systems on the internet.

In one or more implementations, the firewall 816 may protect the inner components of the environment 800 from internet traffic. The firewall 816 may block, permit, or deny access to the inner components of the on-demand database service environment 800 based upon a set of rules and/or other criteria. The firewall 816 may act as one or more of a packet filter, an application gateway, a stateful filter, a proxy server, or any other type of firewall.

In some implementations, the core switches 820 and 824 may be high-capacity switches that transfer packets within the environment 800. The core switches 820 and 824 may be configured as network bridges that quickly route data between different components within the on-demand database service environment. The use of two or more core switches 820 and 824 may provide redundancy and/or reduced latency.

In some implementations, communication between the pods 840 and 844 may be conducted via the pod switches 832 and 836. The pod switches 832 and 836 may facilitate communication between the pods 840 and 844 and client machines, for example via core switches 820 and 824. Also or alternatively, the pod switches 832 and 836 may facilitate communication between the pods 840 and 844 and the database storage 856. The load balancer 828 may distribute workload between the pods, which may assist in improving the use of resources, increasing throughput, reducing response times, and/or reducing overhead. The load balancer 828 may include multilayer switches to analyze and forward traffic.

In some implementations, access to the database storage 856 may be guarded by a database firewall 848, which may act as a computer application firewall operating at the database application layer of a protocol stack. The database firewall 848 may protect the database storage 856 from application attacks such as structure query language (SQL) injection, database rootkits, and unauthorized information disclosure. The database firewall 848 may include a host using one or more forms of reverse proxy services to proxy traffic before passing it to a gateway router and/or may inspect the contents of database traffic and block certain content or database requests. The database firewall 848 may work on the SQL application level atop the TCP/IP stack, managing applications' connection to the database or SQL management interfaces as well as intercepting and enforcing packets traveling to or from a database network or application interface.

In some implementations, the database storage 856 may be an on-demand database system shared by many different organizations. The on-demand database service may employ a single-tenant approach, a multi-tenant approach, a virtualized approach, or any other type of database approach. Communication with the database storage 856 may be conducted via the database switch 852. The database storage 856 may include various software components for handling database queries. Accordingly, the database switch 852 may direct database queries transmitted by other components of the environment (e.g., the pods 840 and 844) to the correct components within the database storage 856.

FIG. 8B shows a system diagram further illustrating an example of architectural components of an on-demand database service environment, in accordance with some implementations. The pod 844 may be used to render services to user(s) of the on-demand database service environment 800. The pod 844 may include one or more content batch servers 864, content search servers 868, query servers 882, file servers 886, access control system (ACS) servers 880, batch servers 884, and app servers 888. Also, the pod 844 may include database instances 890, quick file systems (QFS) 892, and indexers 894. Some or all communication between the servers in the pod 844 may be transmitted via the switch 836.

In some implementations, the app servers 888 may include a framework dedicated to the execution of procedures (e.g., programs, routines, scripts) for supporting the construction of applications provided by the on-demand database service environment 800 via the pod 844. One or more instances of the app server 888 may be configured to execute all or a portion of the operations of the services described herein.

In some implementations, as discussed above, the pod 844 may include one or more database instances 890. A database instance 890 may be configured as an MTS in which different organizations share access to the same database, using the techniques described above. Database information may be transmitted to the indexer 894, which may provide an index of information available in the database 890 to file servers 886. The QFS 892 or other suitable filesystem may serve as a rapid-access file system for storing and accessing information available within the pod 844. The QFS 892 may support volume management capabilities, allowing many disks to be grouped together into a file system. The QFS 892 may communicate with the database instances 890, content search servers 868 and/or indexers 894 to identify, retrieve, move, and/or update data stored in the network file systems (NFS) 896 and/or other storage systems.

In some implementations, one or more query servers 882 may communicate with the NFS 896 to retrieve and/or update information stored outside of the pod 844. The NFS 896 may allow servers located in the pod 844 to access information over a network in a manner similar to how local storage is accessed. Queries from the query servers 822 may be transmitted to the NFS 896 via the load balancer 828, which may distribute resource requests over various resources available in the on-demand database service environment 800. The NFS 896 may also communicate with the QFS 892 to update the information stored on the NFS 896 and/or to provide information to the QFS 892 for use by servers located within the pod 844.

In some implementations, the content batch servers 864 may handle requests internal to the pod 844. These requests may be long-running and/or not tied to a particular customer, such as requests related to log mining, cleanup work, and maintenance tasks. The content search servers 868 may provide query and indexer functions such as functions allowing users to search through content stored in the on-demand database service environment 800. The file servers 886 may manage requests for information stored in the file storage 898, which may store information such as documents, images, basic large objects (BLOBs), etc. The query servers 882 may be used to retrieve information from one or more file systems. For example, the query system 882 may receive requests for information from the app servers 888 and then transmit information queries to the NFS 896 located outside the pod 844. The ACS servers 880 may control access to data, hardware resources, or software resources called upon to render services provided by the pod 844. The batch servers 884 may process batch jobs, which are used to run tasks at specified times. Thus, the batch servers 884 may transmit instructions to other servers, such as the app servers 888, to trigger the batch jobs.

While some of the disclosed implementations may be described with reference to a system having an application server providing a front end for an on-demand database service capable of supporting multiple tenants, the disclosed implementations are not limited to multi-tenant databases nor deployment on application servers. Some implementations may be practiced using various database architectures such as ORACLE®, DB2® by IBM and the like without departing from the scope of present disclosure.

FIG. 9 illustrates one example of a computing device. According to various embodiments, a system 900 suitable for implementing embodiments described herein includes a processor 901, a memory module 903, a storage device 905, an interface 911, and a bus 915 (e.g., a PCI bus or other interconnection fabric.) System 900 may operate as variety of devices such as an application server, a database server, or any other device or service described herein. Although a particular configuration is described, a variety of alternative configurations are possible. The processor 901 may perform operations such as those described herein. Instructions for performing such operations may be embodied in the memory 903, on one or more non-transitory computer readable media, or on some other storage device. Various specially configured devices can also be used in place of or in addition to the processor 901. The interface 911 may be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Apex, Java, Python, C++, C, HTML, any other markup language, JavaScript, ActiveX, VBScript, or Perl. Examples of computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

In the foregoing specification, reference was made in detail to specific embodiments including one or more of the best modes contemplated by the inventors. While various implementations have been described herein, it should be understood that they have been presented by way of example only, and not limitation. For example, some techniques and mechanisms are described herein in the context of a multi-tenant database anomaly detection system. However, the techniques disclosed herein apply to a wide variety of computing environments, such as the detection and management of incidents and anomalies in database systems that are not arranged in a multi-tenant configuration. Particular embodiments may be implemented without some or all of the specific details described herein. In other instances, well known process operations have not been described in detail in order to avoid unnecessarily obscuring the disclosed techniques. Accordingly, the breadth and scope of the present application should not be limited by any of the implementations described herein, but should be defined only in accordance with the claims and their equivalents.

1. A method comprising:
receiving a plurality of input metric values via a communication interface, the plurality of input metric values characterizing one or more operating conditions of a database system;
determining via a processor a plurality of output metric values corresponding to the input metric values by applying a machine learning model to the plurality of input metric values, the machine learning model being pre-trained to project the input metric values into a latent space having a level of dimensionality lower than that of the input metric values, the machine learning model being pre-trained to project the latent space into the output metric values, the output metric values predicting the input metric values;
comparing the output metric values to the corresponding input metric values to identify a plurality of corresponding discrepancy values indicating one or more discrepancies between the output metric values and the corresponding input metric values;
based on the corresponding discrepancy values, determining that a database incident implicating operating conditions corresponding with a portion of the database system has occurred; and
transmitting an instruction to the database system via the communication interface to implement a policy to address the database incident.

2. The method recited in claim 1, wherein determining that the database incident has occurred comprises identifying a subset of the plurality of corresponding discrepancy values that each exceed a respective designated threshold.

3. The method recited in claim 1, wherein the database system is a multitenant database system storing information for a plurality of tenants that access the database system via the Internet.

4. The method recited in claim 3, wherein a subset of the plurality of input metric values are specific to a designated tenant of the plurality of tenants.

5. The method recited in claim 4, wherein determining that the database incident has occurred comprises identifying a designated discrepancy value corresponding with a designated input metric value of the subset of the plurality of input metric values that exceeds a designated threshold.

6. The method recited in claim 5, wherein the database incident is specific to the designated tenant, and wherein the policy is specific to the designated tenant.

7. The method recited in claim 1, wherein the database system is an element of a computing services environment that provides computing services to a plurality of entities via the Internet.

8. The method recited in claim 1, wherein the machine learning model is a variational autoencoder.

9. The method recited in claim 1, wherein the machine learning model is a generative adversarial network.

10. The method recited in claim 1, wherein one or more of the input metric values are specific to a designated time period, and wherein the input metric values include a value selected from the group consisting of: a CPU usage value, a memory usage value, a network bandwidth value, and a number of requests.

11. A system comprising:
a communication interface configured to receive a plurality of input metric values characterizing one or more operating conditions of a database system;
a processor configured to:
determine a plurality of output metric values corresponding to the input metric values by applying a machine learning model to the plurality of input metric values, the machine learning model being pre-trained to project the input metric values into a latent space having a level of dimensionality lower than that of the input metric values, the machine learning model being pre-trained to project the latent space into the output metric values, the output metric values predicting the input metric values, and
compare the output metric values to the corresponding input metric values to identify a plurality of corresponding discrepancy values indicating one or more discrepancies between the output metric values and the corresponding input metric values; and
a policy engine configured to determine that a database incident implicating operating conditions corresponding with a portion of the database system has occurred based on the corresponding discrepancy values and to transmit an instruction to the database system via the communication interface to implement a policy to address the database incident.

12. The system recited in claim 11, wherein determining that the database incident has occurred comprises identifying a subset of the plurality of corresponding discrepancy values that each exceed a respective designated threshold.

13. The system recited in claim 11, wherein the database system is a multitenant database system storing information for a plurality of tenants that access the database system via the Internet.

14. The system recited in claim 13, wherein a subset of the plurality of input metric values are specific to a designated tenant of the plurality of tenants.

15. The system recited in claim 14, wherein determining that the database incident has occurred comprises identifying a designated discrepancy value corresponding with a designated input metric value of the subset of the plurality of input metric values that exceeds a designated threshold.

16. The system recited in claim 15, wherein the database incident is specific to the designated tenant, and wherein the policy is specific to the designated tenant.

17. The system recited in claim 11, wherein the database system is an element of a computing services environment that provides computing services to a plurality of entities via the Internet.

18. One or more non-transitory computer readable media having instructions stored thereon for performing a method, the method comprising:
receiving a plurality of input metric values via a communication interface, the plurality of input metric values characterizing one or more operating conditions of a database system;
determining via a processor a plurality of output metric values corresponding to the input metric values by applying a machine learning model to the plurality of input metric values, the machine learning model being pre-trained to project the input metric values into a latent space having a level of dimensionality lower than that of the input metric values, the machine learning model being pre-trained to project the latent space into the output metric values, the output metric values predicting the input metric values;
comparing the output metric values to the corresponding input metric values to identify a plurality of corresponding discrepancy values indicating one or more discrepancies between the output metric values and the corresponding input metric values;
based on the corresponding discrepancy values, determining that a database incident implicating operating conditions corresponding with a portion of the database system has occurred; and
transmitting an instruction to the database system via the communication interface to implement a policy to address the database incident.

19. The one or more non-transitory computer readable media recited in claim 18, wherein determining that the database incident has occurred comprises identifying a subset of the plurality of corresponding discrepancy values that each exceed a respective designated threshold.

20. The one or more non-transitory computer readable media recited in claim 18, wherein the database system is a multitenant database system storing information for a plurality of tenants that access the database system via the Internet, wherein a subset of the plurality of input metric values are specific to a designated tenant of the plurality of tenants, wherein determining that the database incident has occurred comprises identifying a designated discrepancy value corresponding with a designated input metric value of the subset of the plurality of input metric values that exceeds a designated threshold, and wherein the database incident is specific to the designated tenant, and wherein the policy is specific to the designated tenant.
